(19) United States
(12) Patent Application Publication
(10) Pub. No.: US 2004/0088472 A1
(43) Pub. Date: May 6, 2004

(54) Multi-mode memory controller

(76) Inventors: John M. Nystuen, Burnsville, MN (US); Sandeep J. Sathe, San Jose, CA (US)

Correspondence Address: Timothy R. Croll, LSI LOGIC CORPORATION, M/S D-106, 1551 McCarthy Boulevard, Milpitas, CA, 95035, US

(21) Appl. No.: 10/284,869

(22) Filed: Oct. 31, 2002

(51) Int. Cl. G06F 12/00

(52) U.S. Cl. 711/5; 711/154

(57) ABSTRACT

A memory controller is provided, which includes a request input for receiving successive memory access requests and a memory interface configured for coupling to a memory device having a plurality of banks. The memory controller has a bank control circuit, which generates a bank access command on the memory interface for a respective one of the banks in response to each memory access request to that bank. The bank control circuit has a plurality of selectable operating modes, including a Request Count Mode. When in the Request Count Mode, the bank control circuit generates a bank precharge command on the memory interface for the respective bank if none of a predetermined number of subsequent ones of the memory access requests is to that bank.

### BACKGROUND OF THE INVENTION

The present invention relates to semiconductor integrated circuits and, more particularly to a memory controller for use with memory devices having multiple banks.

Semiconductor memory devices can have many configurations. For example, a typical double data rate (DDR) dynamic random access memory (DRAM) chip includes a plurality of memory arrays, wherein each memory array is divided into four equal sections called banks. For example, a 64 Mbx8 DDR chip would have four banks of two Meg by eight bits each. Each bank is addressed as a whole by a chip select signal and bank address bits. Within each bank, individual rows and columns are addressed by row and column addresses. To provide the desired depth of memory, multiple DDR memory chips can be used. The number of memory chips needed indicates the stack size. Individual chip select signals are used to select a particular stack.

A memory controller is typically used to regulate access to and from the memory device from multiple requesting devices. The memory controller receives memory access requests from the requesting devices along with address information, control signals, write data, etc. The memory controller takes the memory request and decodes the address information into bank, row and column addresses as well as the proper chip select signal. The controller sends the addresses and appropriate control signals to the memory device for performing the requested memory operation, such as a write or a read. For write operations, the memory controller supplies the write data to the memory device along with the write command. For read operations, the controller returns the read data that is retrieved from the memory device to the requesting device.

When performing write and read operations, the memory controller is responsible for generating the appropriate sequence of control signals for accessing the desired address in the memory device. This sequence typically involves precharging the columns in the bank to be accessed, activating the desired row within that bank and then writing to or reading from selected columns in the activated row.

The memory cells at each column are coupled to a respective bit line (or pair of complementary bit lines). Each bit line has a voltage representing the data being read from or written to a memory cell in that column. A sense amplifier is coupled to each bit line (or pair of complementary bit lines) and has a latch for capturing the voltage on that bit line. A precharge command forces the sense amplifier and thus the bit line (or pair of bit lines) to a voltage level between a logic high value and a logic low value. After the bit lines in the memory array have been precharged, the sense amplifiers are ready for an activate command.

The active command operates on a row of the memory. The row address is used to access the proper row in the memory array. The logic level stored within each memory element in the row is driven onto the respective bit lines, which changes the states of the sense amplifiers coupled to those bit lines. After completion of the activate command the memory array is ready for write and read operations to and from that row address. If a different row address is needed, then a new precharge and activate sequence must be executed.

A typical memory controller is implemented as a state machine. There is typically one state machine for each bank in the memory array. In order to improve efficiency of read and write operations, a typical state machine is operable in one of two operating modes known as an Open Bank Mode and an Auto-Precharge Mode. When operating in the Open Bank Mode, the memory controller leaves each bank open after a read command or a write command to enable further reads or writes to the same row of that bank. The Open Bank Mode is desirable when multiple accesses are anticipated within the current column address range for the activated row.

When operating in the Auto-Precharge Mode, the DDR memory automatically generates a precharge command to the respective bank after each read or write command. The Auto-Precharge Mode is desirable when random accesses are being made and no further requests within the current column address range for the open row are anticipated. The Auto-Precharge Mode can save memory bandwidth by not having to perform a precharge command when the next request requires the bank to be closed and then activated to a different row.

Selection between the Open Bank Mode and the Auto-Precharge Mode has typically been performed by the requesting device over the address bus that is coupled between the requesting device and the memory controller. The requesting device determines which mode will be used by setting or clearing a control bit at the time the read or write command is sent to the memory controller.

Although the use of two operating modes improves memory bandwidth, further improvements in bandwidth are desired. Also, the existing approach assumes that the requesting device has enough knowledge or intelligence to determine whether the memory controller should be using the Open Bank Mode or the Auto-Precharge Mode. Often, the requesting device does not have enough information to make this decision. Additionally, many requesting devices do not have the functional capability to make such a decision.

Improved memory controllers are therefore desired that are capable of further increasing memory bandwidth under different operating conditions and with greater intelligence.

### SUMMARY OF THE INVENTION

One embodiment is the present invention is directed to a memory controller, which includes a request input for receiving successive memory access requests and a memory interface configured for coupling to a memory device having a plurality of banks. The memory controller has a bank control circuit, which generates a bank access command on the memory interface for a respective one of the banks in response to each memory access request to that bank. The bank control circuit has a plurality of selectable operating modes, including a Request Count Mode. When in the Request Count Mode, the bank control circuit generates a bank precharge command on the memory interface for the respective bank if none of a predetermined number of subsequent ones of the memory access requests is to that bank.

Another embodiment is the present invention is directed to a method of controlling access to a memory device having a plurality of banks through a memory controller. The method includes (a) receiving successive memory access requests with the memory controller, wherein each memory access request corresponds to one of the banks; (b) generating memory access commands by the memory controller in response to the memory access requests and supplying the memory access commands to the corresponding banks in the memory device; (c) operating the memory controller in one of a plurality of selectable operating modes, including a Request Count Mode; and (d) when operating in the Request Count Mode, for each memory access request received in step (a), supplying a precharge command to the corresponding bank if none of a predetermined number of subsequent ones of the memory access requests corresponds to that bank.

### BRIEF DESCRIPTION OF THE DRAWINGS

FIG. 1 is a diagram illustrating a memory device, which is divided into plurality of banks.

FIG. 2 shows one of the banks of the memory device in greater detail.

FIG. 3 is a diagram illustrating a multimode memory controller, according to one embodiment of the present invention, which is coupled to a memory device such as the one shown in FIG. 1.

FIG. 4 is a diagram of a bank configuration register maintained within the memory controller shown in FIG. 3.

FIG. 5 is a diagram illustrating logic within the memory controller for implementing a Two Request Mode of operation.

FIG. 6 is a state machine diagram illustrating the states of a request state machine within the logic shown in FIG. 5.

FIG. 7 is a state machine diagram illustrating the states of a bank state machine within the logic shown in FIG. 5.

FIG. 8 is a timing diagram illustrating interface signals to memory for typical back-to-back write commands when in a Bank Open Mode and writing to the same row.

FIG. 9 is a timing diagram, which illustrates a sliding window-compare of three latest bank addresses, which is performed when the bank state machine is operating in a Two Request Mode.

### DETAILED DESCRIPTION OF THE PREFERRED EMBODIMENTS

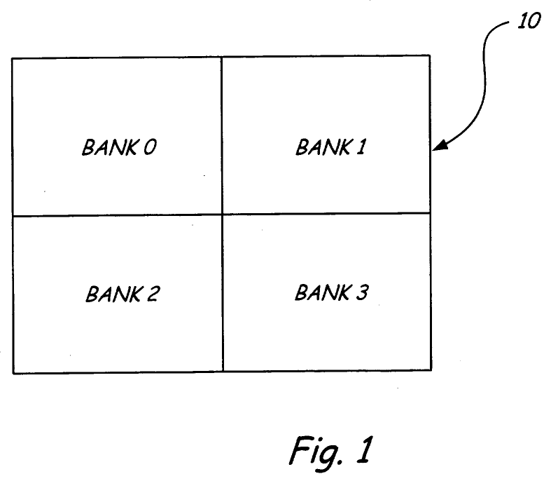

FIG. 1 is a diagram illustrating a memory device 10, which is divided into plurality of banks according to one embodiment of the present invention. In this example, memory device 10 has four banks, labeled BANK 0, BANK 1, BANK 2 and BANK 3. Any number of memory banks can be used in alternative embodiments of the present invention.

Memory device 10 can included any type of memory device, such as a Synchronous Random Access Memory (SRAM), a Dynamic Random Access Memory (DRAM), a Flash Memory, etc. For example in one embodiment, memory device 10 includes a double data rate (DDR) Synchronous Dynamic Access Memory (SDRAM) or a single data rate SDRAM. Other types can also be used.

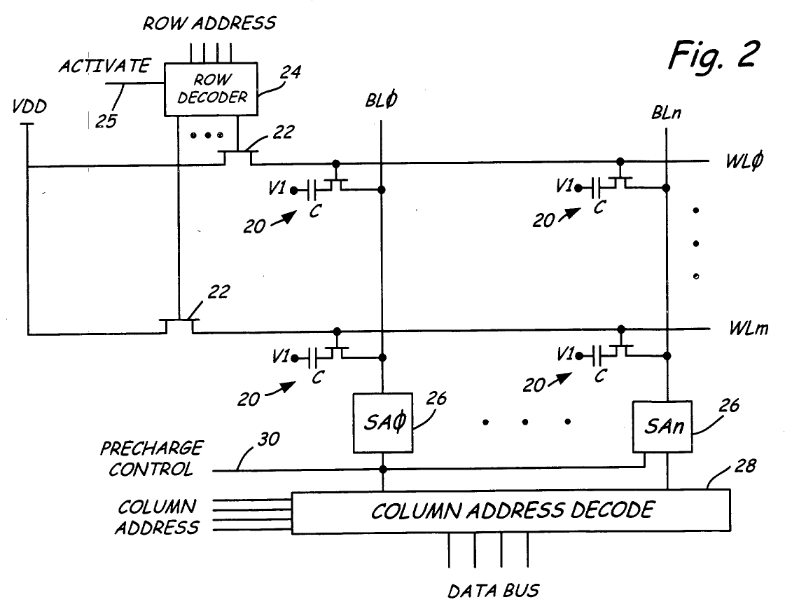

FIG. 2 shows one of the banks of memory device 10 in greater detail. Each bank includes a plurality of memory elements or cells 20, which are arranged in rows and columns. The memory cells 20 in each row are coupled to a common word line, labeled WL0-WLm, where “m” is any suitable integer value. The memory cells 20 in each column are coupled to a common column bit line (or pair of complementary bit lines), labeled BL0-BLn, where “n” is any suitable integer value.

Word lines WL0-WLm are activated through respective select switches 22, which are controlled by a row address decoder 24 as a function of the row address applied to the memory bank. Row address decoder has an activate command input 25, which enables the decoded outputs of the row address decoder to be applied to switches 22. Activate command input 25 is typically encoded into the control signals applied to the memory device. When a particular word line is activated, the charge stored in the memory cells 20 within that row are coupled to bit lines BL0-BLn. A sense amplifier 26 is coupled to each bit line BL0-BLn (or pair of complementary bit lines), and column address decoder 28 multiplexes each bit line BL0-BLn, as sensed by sense amplifiers 26, onto the memory data bus.

During operation, a precharge command received on precharge control input 30 forces the outputs of sense amplifiers 26 and therefore bit lines BLO-BLn to a predetermined state, such as a voltage level between a logic high state and a logic slow state. This precharge command is typically encoded into the control signals applied to the memory device. After bit lines Bl0-BLn have been precharged, sense amplifiers 26 are ready for an activate command. An activate command operates on a row of the memory. The row address provided to row address decoder 24 is used to access the proper row by activating the corresponding word line select switch 22. The charge stored in storage capacitors C of memory cells 20 in the selected row have enough power to change the states of sense amplifiers 26. After completion of an activate command, the memory bank is ready for read and write operations to that row address. If a different row address is needed then a new precharge and activate sequence must be executed.

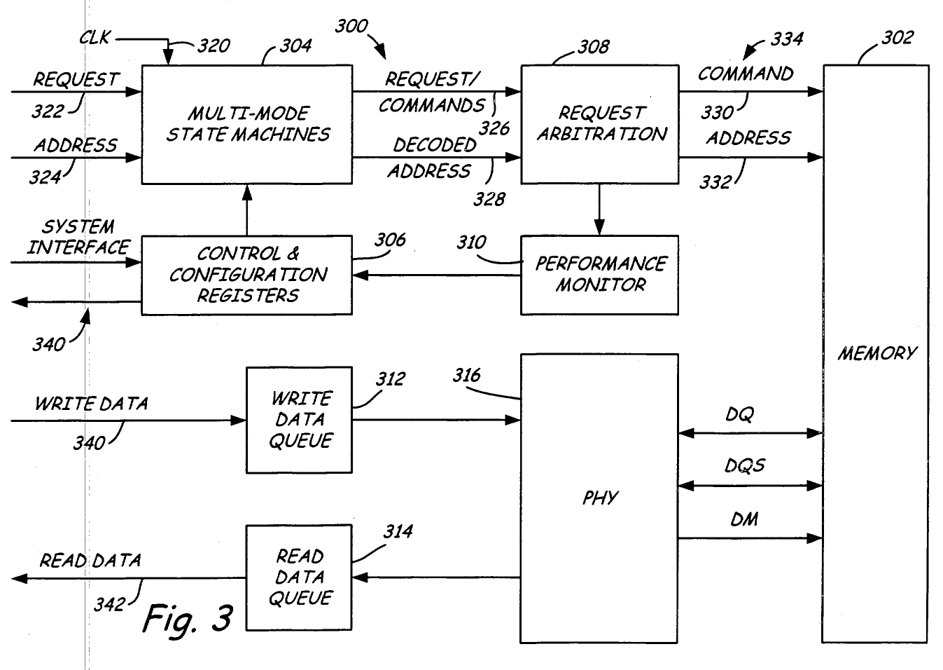

FIG. 3 is a diagram illustrating a multimode memory controller 300, according to one embodiment of the present invention, which is coupled to a DDR SDRAM memory 302. Memory controller 300 includes multi-mode bank state machines 304, control and configuration registers 306, request arbitration circuit 308, performance monitor 310, write data queue 312, read data queue 314 and physical layer interface 316. There is one bank state machine 304 for each bank in memory 302. Each bank state machine 304 has a clock input 320, a request input 322, and an address input 324, a request/command output 326 and a decoded address output 328. Each bank state machine 304 has an internal row address register for storing the address of the last row that was accessed, as well as flags to indicate the status of the bank.

Each bank state machine 304 manages its respective bank in memory 302 by issuing precharge, activate and read/write request commands to that bank over request/command output 326. For each access request received on request input 322, the control logic surrounding bank state machines 304 decodes the address provided on address input 324 and supplies the corresponding bank, row and column addresses onto decoded address output 328 as well as the corresponding chip select signals. In one embodiment, the precharge, activate and read/write request commands are encoded into the control signals provided to memory 302. These control signals can include, for example, a chip select signal (CSn) used to select which chip in a stack of memory chips will be enabled, row address select signals (RASn), column address select signals (CASn), and write enable signals (WEn). Other configurations for issuing commands to memory 302 can also be used.

Request arbitration circuit 308 receives the commands and associated addresses signals from the bank state machines 304, stores the commands and associated addresses signals, and prioritizes the commands for memory 302 from all the bank state machines 304. Request arbitration circuit 308 initiates the highest priority request command by providing the command and associated address signals to outputs 330 and 332 of memory interface 334 and issues an acknowledge signal to the bank state machine 304 whose request was honored. Request arbitration circuit 308 also includes a programmable timing generator, which provides the necessary control signals to memory interface 334, and controls physical layer device 316 for handling the transfer of read or write data over interface 334.

Control and configuration register block 306 provides access to the control functions of memory controller 300 by a system processor or other device over system interface 340. The control and configuration registers within block 306 allow the system processor to use programmable features within memory controller 300, set a desired configuration of multi-mode bank state machines 304, initialize memory 302 and monitor the performance of memory controller 300 through statistics registers maintained by performance monitor 310.

Write data queue 312 is coupled between write data input 340 and physical layer device 316. Similarly, read data queue 314 is coupled between read data output 342 and physical layer device 316. Write data queue 312 provides a buffer for storing write data until the write command associated with the data is initiated by the corresponding bank state machine 304 and request arbitration circuit 308. Read data queue 314 buffers read data received from memory 302 and provides the read data to read data output 342. For DDR memory, read data queue 314 can also include functions for collecting data words read on successive clock edges, setting valid bits for each word and managing tag fields that identify the device or memory controller port that requested the data. Similarly, write data queue 312 can include circuitry for multiplexing the write data to physical layer device 316 for transmission to memory 302 on successive clock edges.

For a DDR type of memory, physical layer device 316 interfaces with memory 302 through a data bus DQ, a bi-directional data strobe signal DQS and a data mask signal DM. Data strobe signal DQS has edges that are aligned relative to changes in read or write data on data bus DQ. A DDR memory transfers data on each rising and falling edge of the DQS signal. A DDR memory therefore transfers two sets of data bits per clock cycle. A “beat” is a generic termed used to indicate a transfer of data during a clock cycle. A beat can be a byte, a word, or another size that is being transferred. Write data queue 312 is therefore twice the width of data bus DQ in order to provide data at the double rate. Similarly, read data queue 314 is twice the width of memory data bus DQ in order to receive data at the double rate. Request arbitration circuit 308 provides timing signals to physical layer device 316 that ensure the write and read data is transferred at the correct times.

For successive memory access requests to the same bank, the decoded row address and stack field for the request is compared to that stored in the row address register maintained by the corresponding bank state machine 304. The row address register contains an active flag, controlled by the state machine, which indicates whether the bank is open for accesses at the row address and stack contained in the remainder of the register. If the active flag is inactive, the other fields in the bank register are “don't care”. If the decoded row address and stack field for the new request matches those stored in the row address register of that bank, then the requested accesses is ready to be executed. Otherwise, the respective bank must be precharged, the new row address must be loaded into the row address register, and the new row must be activated before the memory access can be initialed.

As described in more detail below, multi-mode bank state machines 304 are each operable in a plurality of selectable operating modes so that the most efficient operating mode in terms of memory bandwidth can be selected. In one embodiment, each bank state machine 304 is operable in an Auto-Precharge Mode, a Request Count Mode (e.g., a Two Request Mode), and a Bank Open Mode. When a bank state machine operates in the Auto-Precharge Mode, memory 302 automatically precharges the respective bank after executing any read or write command regardless of the following memory request to that bank. This mode is most effective when random addresses are being requested.

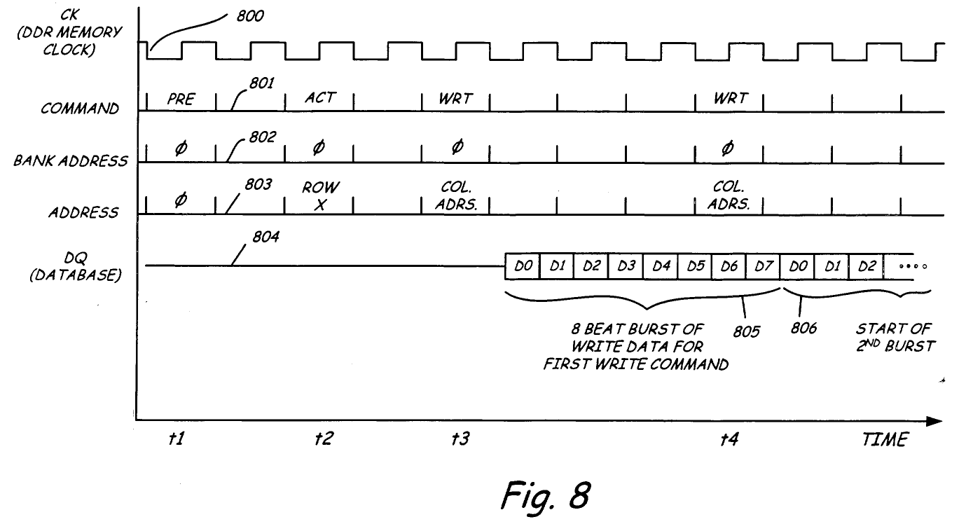

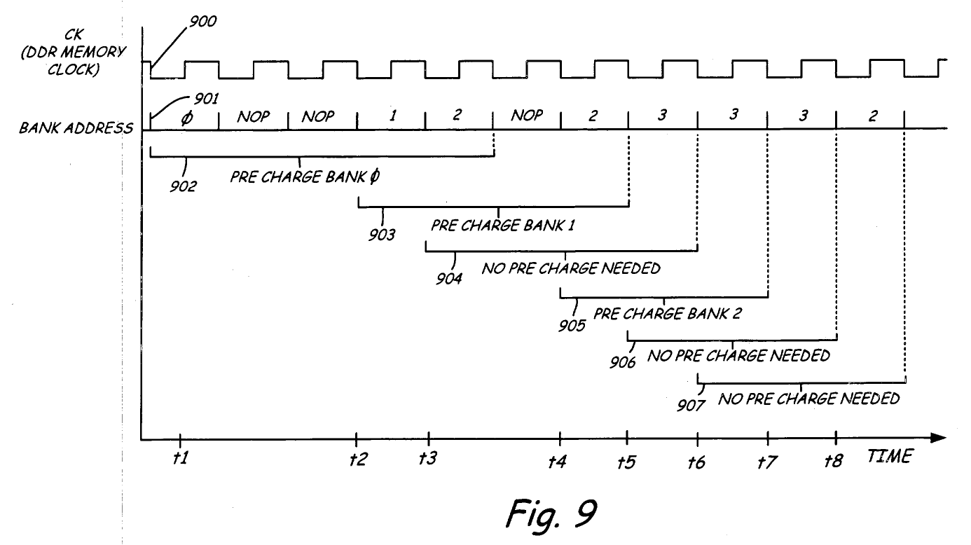

When operating in the Request Count Mode, the bank state machine precharges the respective bank if a predetermined number of following memory requests are not directed to that bank. For example in one embodiment, the predetermined number is two subsequent memory requests. A bank is precharged if neither of the next two memory requests received on request input 322 is directed to that bank. This is a comprise mode between the Auto-Precharge Mode and the Bank Open Mode. The Request Count Mode is especially effective when using eight beat bursts, for example. The precharge command for the previous bank and the activate command for the new bank can be completely hidden within intermediate, unused clock cycles of the command bus 330 when using eight beat bursts. For example, the precharge and activate commands can be hidden when many write bursts are made to a row in any memory chip (any bank) or many read bursts are made from a row of a single memory chip (any bank within that chip). These hidden commands are described in more detail below with respect to FIGS. 8 and 9.

When operating in the Bank Open Mode, a bank state machine leaves the corresponding bank open (not precharged) as long as possible until a memory request is made to a different row in that bank. This mode is effective when there are a lot of sequential address requests.

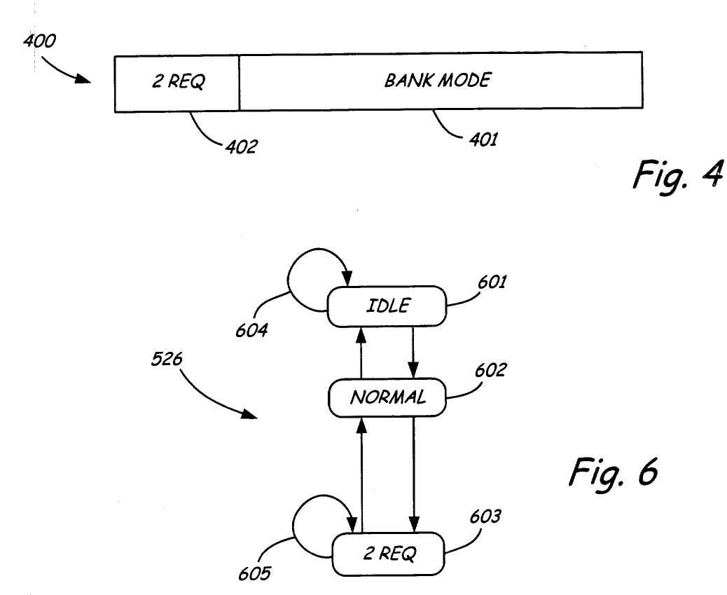

FIG. 4 is a diagram of a bank configuration register 400 maintained within control and configuration register block 306. Register 400 has a bank mode field 401 for setting the operating modes of bank state machines 304. There is at least one bit in bank mode field 401 for each bank state machine 304. Register 400 further includes a Two Request Mode field 402, which is shared among all banks in one embodiment of the present invention. When the Two Request Mode field 402 is set active (e.g., high), it forces all bank state machines into the Two Request Mode. Therefore, this field overrides the bank mode bits in field 401. In an alternative embodiment, the field 402 does not override field 401, but is simply encoded with field 401 to determine the operating modes of bank state machines 304.

Bank mode fields 401 are used by bank state machines 304 when the Two Request Mode field 402 is inactive. Bank mode field 401 has at least one bit for each bank in memory 302. In one embodiment, if a particular bit is reset to an inactive state, the corresponding bank operates in the Bank Open Mode. If a particular bit is set active, the corresponding bank operates in the Auto-Precharge Mode.

Bank configuration register 400 can be written at any time by the system processor (or other device) over system interface 340 (shown in FIG. 3).

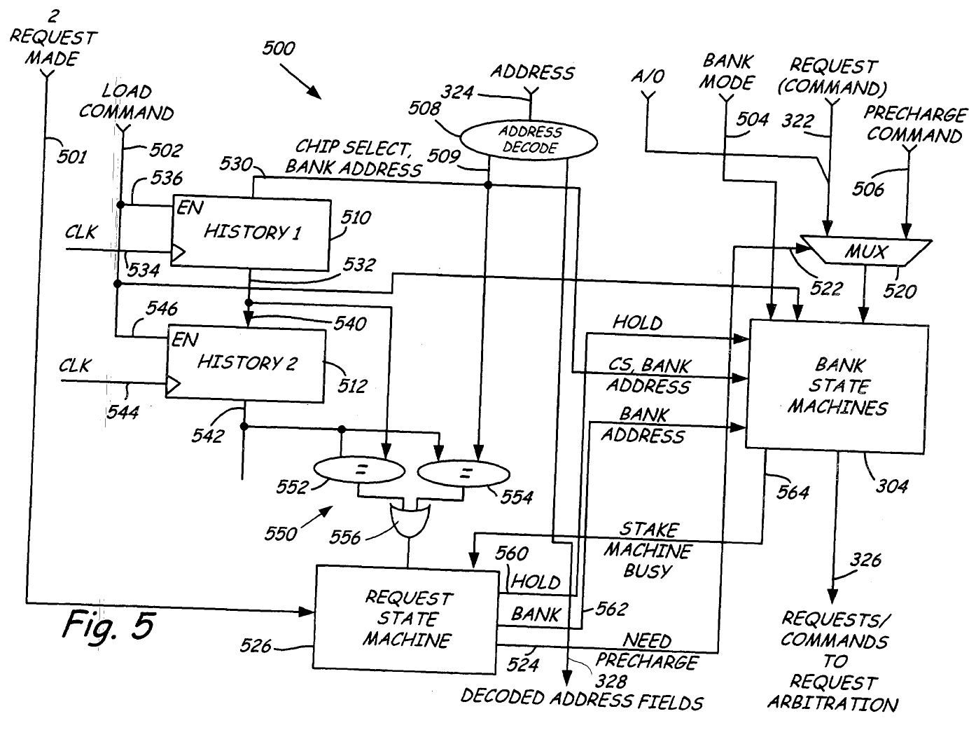

FIG. 5 is a diagram illustrating the control logic 500 surrounding bank state machines 304 for implementing the Two Request Mode of operation. Control logic 500 includes Two Request Mode input 501, load command input 502, address input 324, AutoBank Mode input 504, request input 322, precharge command input 506, decoded address output 328, and request/command output 326. The address for each incoming memory access request is decoded by address decode circuit 508, and the decoded chip select, bank address, row address and column address are provided to decoded address output 328.

The chip select and bank address fields of the decoded address are also provided to bank decode output 509, which is coupled to history registers 510 and 512 and to bank state machines 304. The chip select and bank address fields point to the specific bank state machine 304 that will handle the incoming request. These fields are used by the bank state machine 304 to load the request into its state machine for execution.

Bank Mode input 504 is coupled to bank mode field 401 of the bank configuration register 400 (shown in FIG. 4), and individual bits of the bank mode field are coupled to a respective one of the bank state machines 304. Request input 322 is coupled to a first input of multiplexer 520, and PRECHARGE command input 506 is coupled to a second input multiplexer 520. The output multiplexer 520 is coupled to bank state machines 304. Multiplexer 520 has a select input 522, which is coupled to a NEED PRECHARGE output 524 of request state machine 526. In one embodiment, precharge command 506 is hard-wired to form a logic pattern corresponding to a PRECHARGE command. Multiplexer 520 passes the incoming memory access request from request input 322 or the PRECHARGE command from PRECHARGE command input 506 to bank state machines 304 as a function of the state of NEED PRECHARGE output 524.

Each successively received memory access request or the PRECHARGE command is loaded into the respective bank state machine, as identified by the decoded chip select and bank address fields on decoded output 509, when load command input 502 becomes active. Based on the command received from multiplexer 520 and the current state of the state machine, the corresponding bank state machine generates a command on request/command output 326.

History registers 510 and 512 are connected together in series with one another to form a shift register that stores a history of the banks that were accessed with the last two most recent memory access requests. History register 510 has a data input 530 coupled to decode output 509 of address decode circuit 508, a data output 532 coupled to history register 512, a clock input 534 coupled to clock CLK and an enable input 536 coupled to load command input 502. History register 512 has a data input 540 coupled to data output 532 of history register 510, a data output 542, a clock input 544 coupled to clock CLK and an enable input 546 coupled to load command input 502.

As each successive command is loaded into one of the bank state machines 304, the corresponding chip select and bank address are loaded into history register 510. The chip select and bank address of the previous memory access request, which was stored in history register 510, is loaded into history register 512. Therefore, as the next memory access request arrives on request input 322 history registers 510 and 512 will contain the chip select and bank addresses of the previous two memory access requests.

Compare circuit 550 compares the chip select and bank address stored in history register 512 with the chip select and bank address stored in history register 510 and the chip select and bank address presently received on address input 324 to determine whether either of the two requests is to the same bank as that stored in register 512. Compare circuit 550 includes comparator 552, comparator 554 and logic-OR gate 556. Comparator 552 has a first input coupled to output 542 of history register 512 and a second input coupled to output 532 of history register 510. Comparator 554 has a first input coupled to output 542 of history register 512 and a second input coupled to decode output 509. The outputs of comparators 552 and 554 are coupled to the inputs of logic-OR gate 556. The output of logic-OR gate 556 is coupled to request state machine 526. The output of logic-OR gate 556 has a logic high state if at least one of the two requests that follow the request corresponding to the chip select and bank address stored in history register 512 are to the same bank. If not, the output of logicOR gate 556 has a logic low state.

Request state machine 526 controls the operating state of bank state machines 304 based on the output of compare circuit 550 and the state of Two Request Mode input 501. If one of the following two requests are to the same bank is that stored in history register 512, request state machine 526 clears HOLD output 560 and NEED PRECHARGE output 524 to inactive states. If neither of the following two requests is to that bank, request state machine 526 sets HOLD output 560 to the active state, which prevents bank state machines 304 from accepting any new requests from request input 322. Request state machine 526 monitors STATE MACHINE BUSY output 564 to determine when bank state machines 304 are not busy. When STATE MACHINE BUSY output 564 goes inactive, request state machine 526 sets the NEED PRECHARGE output 524 active, which allows the PRECHARGE command on PRECHARGE COMMAND input 506 to be loaded into the bank state machine that is specified by the BANK address output 562 of request state machine 526. The PRECHARGE command can then be executed by the corresponding state machine to precharge the bank identified in history register 512.

FIG. 6 is a state machine diagram illustrating the states of request state machine 526 that relate to the Two Request Mode of operation. State machine 526 has an idle state 601, a normal state 602 and a “2 REQ” state 603. Request state machine 526 remains in the idle state 601, as indicated by arrow 604, until the memory controller generates a start signal indicating that it is ready to start taking memory access requests. State machine 526 then moves to normal state 602 in which the NEED PRECHARGE output 524 and the HOLD output 560 are held inactive, thereby allowing bank state machines 304 to accept memory access requests. If the Two Request Mode input 501 (shown in FIG. 5) is active and if the following two requests are not to the same bank as the bank stored in history register 512, state machine 526 moves to 2 REQ state 603 to issue a precharge command. State machine 526 remains in state 603, as shown by arrow 605, if state machines 304 are busy. When the state machines 304 are not busy, request state machine 526 activates the NEED PRECHARGE output 524, such that the corresponding bank state machine can issue the PRECHARGE command. Request state machine 603 then returns to normal state 602.

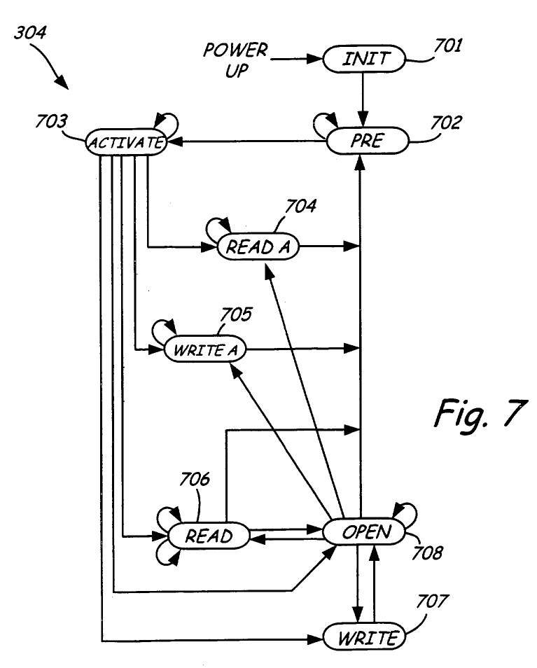

FIG. 7 is a state machine diagram illustrating the states of one of the bank state machines 304 (shown in FIG. 5). Upon power up, bank state machine 304 enters initialize state 701. Once initialized, the bank state machine transitions to precharge state 702. In precharge state 702, bank state machine 304 generates a precharge command to close the corresponding bank. Thereafter, the bank must be opened before any read or write accesses. Once a memory access request has been received for that bank, bank state machine 304 enters activate state 703 at which the command outputs are encoded to activate the row in that bank that is identified by the incoming address. Once the addressed row has been activated at state 703, the bank is open and a read or write burst can start immediately from any one of the states 704, 705, 706 or 707. If there are no pending memory access requests, bank state machine 304 enters open state 708 at which the bank is open for a read or write command.

If a read or write command is to be executed and bank state machine 304 is in the Auto-Precharge Mode, the state machine enters state 704 or 705 to perform the read or write operation. Once the read or write operation has executed, bank state machine automatically returns to precharge state 702, and the bank is closed.

If bank state machine 304 is in the Open Bank Mode, the state machine enters state 706 or 707 to perform the read or write operation. Once the read or write operation has executed, bank state machine 304 returns to open state 708, and the bank remains open for subsequent read or write commands. If the next subsequent read or write command is to the same row, bank state machine 304 can return directly to read state 706 or write state 707 without precharging the bank. If the next subsequent read or write command is to a different row, bank state machine 304 transitions from open state 708 to precharge state 702 so that the bank can be precharged and re-activated to the new row. Also, bank state machine 304 can return to the precharge state 702 from open state 708 when operating in the Two Request Mode if the following two requests received by the memory controller are not to that bank. That bank is then closed.

FIG. 8 is a timing diagram illustrating the interface signals to memory 302 (shown in FIG. 3) for typical back-to-back write commands when in the Bank Open Mode and writing to the same row. Waveform 800 represents the DDR memory clock signal, CK, provided to memory 302 during a write command. Waveform 801 symbolically represents the different encoded precharge, activate, and write commands sent to memory 302 to perform the write operations. Waveform 802 symbolically represents the bank address to which the commands are being directed. Waveform 803 symbolically represents the row and column addresses to which each command is directed. Waveform 804 symbolically represents the data applied to the DQ data bus over time.

In this example, bank 0 is being accessed, and it is assumed that bank 0 needs to be precharged. At time t1, the bank state machine generates the PRECHARGE command (labeled “PRE”) to precharge bank 0. At time t2, the bank state machine generates an ACTIVATE command (labeled “ACT”) for row X in bank 0. At time t3, the bank state machine generates a WRITE command (labeled “WRT”) to begin writing an 8-beat burst 805 of write data to the column address applied to the column address field. The 8-beat burst of write data is labeled D0-D7 in the DQ data bus waveform 804. At time t4, a second write command is generated to start a second 8-beat burst 806 of write data to the next column address specified in bank 0.

The first write burst 805 took five DQS clock cycles to get the WRITE command sent because the bank first needed a precharge command and an activate command. The second write burst 806 was sent at the first possible time to maximize the memory bandwidth by ensuring there are no gaps of data on the DQ data bus.

FIG. 9 is a timing diagram, which illustrates a sliding window-compare of the three latest bank addresses, which is performed when the bank state machine is operating in the Two Request Mode. Waveform 900 represents the DDR memory clock signal CK. Waveform 901 represents the bank address of the current memory access request. Brackets 902-907 represent a sliding window-compare of the three latest bank addresses. For simplicity, the command, row address, column address and data bus are not shown in FIG. 9.

At t1, a request is received to access bank 0. No further requests are received in the next two clock cycles, and these inactive periods are labeled “NOP” for “no operation”. At time t2, a request is received to access bank 1. At time t3, a request is received to access bank 2. Since the next two requests received at times tl and t2 following the request to bank 0 at t1 are to banks other than bank 0, as indicated by sliding window 902, bank 0 is precharged after the request to bank 2 is received. At time t4, a request to access bank 2 is received. Since the requests received at times t3 and t4 are not to bank 1, as indicated by sliding window 903, bank 1 is closed precharged after the request to access bank 2 at time t4 is received. At time t5, a request to access bank 3 is received. However since one of the two requests at times t4 and t5 is to the same bank as the request at time t3, namely to bank 2, as indicated by sliding window 904, no precharge of bank 2 two is needed.

A request to access bank 3 is received at time t6, causing bank 2 to be precharged, as indicated by sliding window 905. Another request to access bank 3 is received at time t7, but since the previous two requests where also to bank 3, bank 3 does not need to be precharged, as indicated by sliding window 906. Finally, a request to access bank 2 is received at time t8, but a comparison of the last two requests, as indicated by sliding window 907, results in no precharge of bank 3.

The Two Request Mode essentially leaves two banks activated (the most recently used banks) and precharges all other banks. As shown in FIG. 9, a sliding window 902-907 is used for the last three requests. The bank addresses for the last three requests are compared. The oldest request is compared with the other two requests, and if it does not match either of the other two requests, the bank corresponding to the oldest request must be precharged.

The Two Request Mode is very effective when long bursts of reads or writes are performed with 8-beat bursts, for example. Table 1 illustrates similar information as FIGS. 8 and 9, but in table form. Each row in Table 1 represents one DDR memory clock cycle.

TABLE 1
String of Write Commands

| | | | | DQ Data |
|---|---|---|---|---|
| CLK | Command | Bank | Address | Bus |
| 1 | ACTIVATE | 0 | Row W | |
| 2 | NOP | | | |
| 3 | WRITE | 0 | Column | |
| 4 | ACTIVATE | 1 | Row X | D0, D1 |
| 5 | NOP | | | D2, D3 |
| 6 | NOP | | | D4, D5 |
| 7 | WRITE | 1 | Column | D6, D7 |
| 8 | ACTIVATE | 2 | Row Y | D0, D1 |
| 9 | NOP | | | D2, D3 |
| 10 | PRECHARGE | 0 | | D4, D5 |
| 11 | WRITE | 2 | Column | D6, D7 |
| 12 | ACTIVATE | 3 | Row Z | D0, D1 |
| 13 | NOP | | | D2, D3 |
| 14 | PRECHARGE | 1 | | D4, D5 |
| 15 | WRITE | 3 | Column | D6, D7 |
| 16 | ACTIVATE | 0 | Row W | D0, D1 |
| 17 | NOP | | | D2, D3 |
| 18 | PRECHARGE | 2 | | D4, D5 |
| 19 | WRITE | 0 | Column | D6, D7 |
| 20 | ACTIVATE | 1 | Row X | D0, D1 |
| 21 | NOP | | | D2, D3 |
| 22 | PRECHARGE | 3 | | D4, D5 |
| 23 | WRITE | 1 | Column | D6, D7 |
| 24 | ACTIVATE | 2 | Row Y | D0, D1 |
| 25 | NOP | | | D2, D3 |
| 26 | PRECHARGE | 0 | | D4, D5 |
| 27 | WRITE | 2 | Column | D6, D7 |
| 28 | ACTIVATE | 3 | Row Z | D0, D1 |
| 29 | NOP | | D2, D3 | |
| 30 | PRECHARGE | 1 | | D4, D5 |
| 31 | WRITE | 3 | Column | D6, D7 |
| 32 | ACTIVATE | 0 | Row W | D0, D1 |
| 33 | NOP | | D2, D3 | |
| 34 | PRECHARGE | 2 | | D4, D5 |
| 35 | WRITE | 0 | Column | D6, D7 |
| 36 | ACTIVATE | 1 | Row X | D0, D1 |
| 37 | NOP | | D2, D3 | |
| 38 | PRECHARGE | 3 | | D4, D5 |
| 39 | WRITE | 1 | Column | D6, D7 |
| 40 | ACTIVATE | 2 | Row Y | D0, D1 |

The sequence of requests shown in Table 1 is:

Write request-bank 0

Write request-bank 1

Write request-bank 2

Write request-bank 3

Write request-bank 0

Write request-bank 1

Write request-bank 2

Write request-bank 3

Write request-bank 0

Write request-bank 1

At the beginning of the sequence shown in Table 1, it is assumed that all banks are precharged. Eight word bursts are shown and are labeled D0-D7. An analysis of Table 1 shows several things. First, the DQ data bus has maximum utilization with no gaps between bursts. Write requests rotate through each bank 0-3. This can be implemented by the programmer by interleaving the data queues so that a string of write or read requests will result in a request stream similar to that shown in Table 1. All precharge and activate requests can be hidden commands. In other words, the precharge and activate commands can be inserted during NOP cycles of write or read commands. Also, all write or read requests can be to the same row address or a different row address within a bank. It makes no difference from a performance issue since all precharge and activate commands are hidden.

The choice of three operating modes provides the designer flexibility based on the application in which the memory controller is used. The efficiency in each mode is application-dependent. Performance can be monitored in several ways, such as through hardware (performance monitor 310 shown in FIG. 3), by the use of different memory mappings by the programmer, and by trial and error, for example. The choice of operating mode is programmable and can be changed at any time through the system interface to the memory controller. In one embodiment, the memory controller allows any change in operating mode to become effective during the next refresh cycle.

As mentioned above, performance monitor 310 maintains several performance monitor registers. These registers can be used to determine the configurations or achieving the best system performance. In one embodiment of the present invention, there are ten types of performance monitor registers. These include, for example:

Interval Timer, which measures the number of clock cycles elapsed during the monitoring;

Request Counter, which measures the total number of commands (except NOP and Deselect) sent to the memory during the monitoring;

Read Counter, which measures the total number of read bursts that have been requested from the memory during the monitoring;

Write Counter, which measures the total number of write bursts that have been sent to the memory during the monitoring;

Bank Miss Rate, which measures the total number of bank misses during the monitoring (this is approximated by counting the number of bank precharge commands, not including precharge all commands);

Refresh, which measures the total number of refresh commands that have been initiated during the monitoring;

Priority 3 Requests, which measures the total number of priority level 3 commands that have been initiated during the monitoring;

Priority 2 Requests, which measures the total number of priority level 2 commands that have been initiated during the monitoring;

Priority 1 Requests, which measures the total number of priority level 1 commands that have been initiated during the monitoring; and

Priority 0 Requests, which measures the total number of priority level 0 commands that have been initiated during the monitoring.

Priority level 3 commands are precharge, activate, read and write. Priority level 3 is the highest priority a request can have and indicates that it is the next request to be sent to the memory. A priority level 2 request would be assigned to the next request in the queue and so on. Priority level 2 commands are precharge and activate From this data several different observations of that can be made, such as the ratio of reads to writes, the percentage of available bandwidth used, how much overhead it took to get that bandwidth, how well were open banks being utilized and how well were hidden commands utilized.

The embodiment shown in the above-figures also allows the “smartest” element (e.g., a processor) to control the bank mode for each bank state machine. In different embodiments, the smartest element may vary. This provides maximum flexibility. In addition, the current bank mode can be changed dynamically.

Although the present invention has been described with reference to preferred embodiments, workers skilled in the art will recognize that changes may be made in form and detail without departing from the spirit and scope of the invention. For example, the particular interfaces and control logic can vary depending on the type of memory used. Also, the manner in which the bank addresses are collected and compared can vary in alternative embodiments. Portions of the memory controller can be implemented in hardware, software or a combination of both hardware and software. In addition, the term “coupled” used in the specification and the claims can include a direct connection or a connection through one or more intermediate elements.

What is claimed is:

1. A memory controller comprising:
a request input for receiving successive memory access requests;
a memory interface configured for coupling to a memory device having a plurality of banks; and
a bank control circuit which generates a bank access command on the memory interface for a respective one of the banks in response to each memory access request to that bank, wherein the bank control circuit comprises a plurality of selectable operating modes, including a Request Count Mode in which the bank control circuit generates a bank precharge command on the memory interface for the respective bank if none of a predetermined number of subsequent ones of the memory access requests is to that bank, wherein the predetermined number is greater than one.

2. The memory controller of claim 1 wherein the predetermined number is two.

3. The memory controller of claim 1 wherein the bank control circuit further comprises:
an auto pre-charge mode in which the memory automatically generates a bank precharge for the respective bank after generating the bank access command for that bank; and
a Bank Open Mode in which the bank control circuit leaves the respective bank open after each bank access command.

4. The memory controller of claim 3 wherein the bank control circuit further comprises:
a bank state machine for each of the plurality of banks, wherein each bank state machine comprises the plurality of selectable operating modes; and
a bank configuration register having mode control bit locations with logic states that define the operating mode in which each of the bank state machines operates.

5. The memory controller of claim 4 and further comprising:
a system bus interface, which is coupled to the bank configuration register and enables the bank configuration register to be modified through the system bus interface.

6. The memory controller of claim 4 wherein:
the request input comprises a command input and an address input, the address input comprising a precharge control field; and
each bank state machine further comprises a bank command input coupled to the command input of the memory controller for receiving each of the memory access requests to the respective bank, and further coupled to the precharge control field of the address input, wherein when the precharge control field within one of the memory access requests is active, the bank state machine for the respective bank generates a precharge command on the memory interface prior to generating the corresponding bank access command on the memory interface, regardless of the logic states of the mode control bit locations in the bank configuration register.

7. The memory controller of claim 1 and further comprising:
an address decode circuit coupled to an address field of the request input and having a decoded bank address output, which for each memory access request identifies a respective one of the banks in the memory device;
a shift register, which is coupled to the decoded bank address output and stores the decoded bank address outputs of a plurality of most recently received ones of the memory access requests; and
a comparator, which is coupled to the shift register and the request input and compares the bank address output of an earliest one of the most recently received memory access requests with the bank address outputs of the other most recently received memory access requests and with the bank address output of a presently received memory access request on the request input.

8. The memory controller of claim 7 wherein the comparator comprises an output, which has an active state if none of the bank address outputs of the predetermined number of subsequent ones of the memory access requests equals the bank address output of the earliest one of the most recently received memory access requests.

9. The memory controller of claim 8 wherein the bank control circuit generates the bank precharge command on the memory interface as a function of the output of the comparator.

10. The memory controller of claim 5 and further comprising performance monitor means for monitoring the bank access commands on the memory interface and for maintaining corresponding statistical data in a set of registers, which are accessible over the system bus interface.

11. A memory controller comprising:
a request input for receiving successive memory access requests;
a memory interface configured for coupling to a memory device having a plurality of banks; and
bank control means for generating a bank access command on the memory interface for a respective one of the banks in response to each memory access request, wherein the bank control means is operable in a plurality of selectable operating modes, including a Request Count Mode in which the bank control means generates a bank precharge command on the memory interface for the respective bank if none of a predetermined number of subsequent ones of the memory access requests is to that same bank, wherein the predetermined number is greater than one.

12. The memory controller of claim 11 wherein the predetermined number is two.

13. The memory controller of claim 11 wherein the plurality of selectable operating modes further comprises:
an auto pre-charge mode in which the bank control means generates a bank precharge command on the memory interface automatically for the respective bank after generating the bank access command for that bank; and
a Bank Open Mode in which the bank control means leaves the respective bank open after each bank access command.

14. The memory controller of claim 13 wherein the bank control means further comprises:
bank state machine means for each of the plurality of banks, wherein each bank state machine means comprises the plurality of selectable operating modes; and
a bank configuration register having mode control bit locations with logic states that define the operating mode in which each of the bank state machine means operates.

15. The memory controller of claim 14 and further comprising:
a system bus interface, which is coupled to the bank configuration register and enables the bank configuration register to be modified through the system bus interface.

16. The memory controller of claim 14 wherein:
the request input comprises a command input and an address input, the address input comprising a precharge control field; and
each bank state machine means further comprises a bank command input coupled to the command input of the memory controller for receiving each of the memory access requests to the respective bank, and further coupled to the precharge control field of the address input, wherein when the precharge control field within one of the memory access requests is active, the bank state machine means for the respective bank generates a precharge command on the memory interface prior to generating the corresponding bank access command on the memory interface, regardless of the logic states of the mode control bit locations in the bank configuration register.

17. The memory controller of claim 11 and further comprising:
means for decoding an address field of the request input into a decoded bank address for each memory access request, which identifies a respective one of the banks in the memory device;
means for storing the decoded bank addresses of a plurality of most recently received ones of the memory access requests; and
means for comparing the bank address of an earliest one of the most recently received memory access requests with the bank addresses of the other most recently received memory access requests and with the bank address output of a presently received memory access request on the request input to produce a compare output.

18. The memory controller of claim 17 wherein the bank control means generates the bank precharge command on the memory interface as a function of the compare output.

19. The memory controller of claim 15 and further comprising performance monitor means for monitoring the bank access commands on the memory interface and for maintaining corresponding statistical data in a set of registers, which are accessible over the system bus interface.

20. A method of controlling access to a memory device having a plurality of banks through a memory controller, the method comprising:
(a) receiving successive memory access requests with the memory controller, wherein each memory access request corresponds to one of the banks;
(b) generating memory access commands by the memory controller in response to the memory access requests and supplying the memory access commands to the corresponding banks in the memory device;
(c) operating the memory controller in one of a plurality of selectable operating modes, including a Request Count Mode; and
(d) when operating in the Request Count Mode, for each memory access request received in step (a), supplying a precharge command to the corresponding bank if none of a predetermined number of subsequent ones of the memory access requests corresponds to that bank, wherein the predetermined number is greater than one.
